(19) United States
(12) Patent Application Publication
(10) Pub. No.: US 2024/0083302 A1
(43) Pub. Date: Mar. 14, 2024

(54) Advanced Battery Bank and Management Thereof

(71) Applicant: Dometic Sweden AB, Solna (SE)

(72) Inventors: Taylor Townsend, Victoria (CA); Mark Spilsbury, Victoria (CA); Kyle Cameron, Victoria (CA); Sean O'Connor, Victoria (CA)

(21) Appl. No.: 18/466,456

(22) Filed: Sep. 13, 2023

Related U.S. Application Data
(60) Provisional application No. 63/406,483, filed on Sep. 14, 2022.

(51) Int. Cl. B60L 58/22; B60L 58/12; B60L 58/16; B60L 58/27

(52) U.S. Cl. CPC B60L 58/22; B60L 58/12; B60L 58/16; B60L 58/27; H01M 10/4257

(57) ABSTRACT

Embodiments described herein relate to a battery bank and techniques for managing batteries of the battery bank. For example, the battery bank may include at least a primary battery and a secondary battery. In various embodiments, processor(s) of a primary battery management system (BMS) of the primary battery may monitor battery diagnostic information for the battery bank, receive an indication to charge the battery bank from a central controller that is communicatively coupled to the battery bank, select a given battery to be charged from among at least the primary battery and the secondary battery, and cause the given battery to be charged. In various embodiments, the primary BMS may be internal to the primary battery. In various embodiments, the secondary battery may include a corresponding secondary BMS to communicate with the primary BMS to enable the processor(s) of the primary BMS to monitor the battery diagnostic information.

### CLAIM TO PRIORITY

This non-provisional patent application claims priority to and benefit of, under 35 U.S.C. § 119(e), U.S. Provisional Patent Application 63/406,483, filed Sep. 14, 2022 and titled “Advanced Battery Bank and Management Thereof”, all of which is incorporated by reference herein.

### BACKGROUND

### Technical Field

Embodiments provide a battery bank and techniques for managing batteries of the battery bank. More particularly, but without limitation, processor(s) of a primary battery management system (BMS) of a primary battery may monitor battery diagnostic information for the battery bank, receive an indication to charge the battery bank from a central controller that is communicatively coupled to the battery bank, select a given battery to be charged from among at least the primary battery and a secondary battery, and cause the given battery to be charged.

### Description of Related Art

Batteries have been one of the primary sources of portable electricity for the better part of the past century. In many cases, batteries are rechargeable in that they may be charged, discharged as an electrical load, and recharged many times. For example, the lead-acid battery is considered by many to be the first rechargeable battery ever developed, and is still heavily utilized in vehicular applications today (i.e., automobile starting, lighting, and ignition batteries). While the lead-acid batteries are widely viewed as being a reliable and cost effective option, they have a relatively short lifespan and require regular maintenance, thereby rendering them undesirable for other applications. As another example, the lithium battery is a more recently developed rechargeable battery, and is heavily utilized across a wider variety of applications including consumer electronics applications (e.g., mobile phones, laptops and tablets, digital cameras, gaming consoles, etc.) and vehicle applications as well (i.e., electric vehicle or hybrid vehicle batteries, recreational vehicle (RV) or motorhome batteries, etc.). While the lithium batteries are more cost prohibitive, they have a relatively longer lifespan and require less maintenance, thereby rendering them more desirable across the wider variety of applications.

Multiple rechargeable batteries, such as a battery bank, are generally controlled by one or more battery management systems (BMS(s)) to manage each of the batteries of the battery bank. These BMS(s) may be internal to each of the batteries of the battery bank (e.g., internal BMS(s)) or external to each of the batteries of the battery bank (e.g., external BMS(S)), and utilized for a variety of different purposes. For example, external BMS(s) may be utilized to communicate between the battery bank and an external system that is external to the battery bank (e.g., a central controller of a system that utilizes power of the battery bank). As another example, internal BMS(s) may be utilized to manage and protect a corresponding battery of the battery bank (e.g., prevent thermal runaway of the corresponding battery, protect corresponding battery cells of the corresponding battery), while external BMS(s) may be utilized to manage and balance the batteries of the battery bank. In balancing the batteries of the battery bank, the external BMS(s) may seek to maximize the capacity of each of the batteries of the battery bank and lifespan of each of the batteries of the battery bank by, for instance, preventing overcharging and/or under-charging of each the batteries of the battery bank, monitoring battery performance and/or health of each of the batteries of the battery bank, and so on.

Generally, external BMS(s) are manually configured prior to utilization of the battery bank. For example, external BMS(s) may be manually configured with high and low voltage limits for faults for each of the batteries, maximum charge and discharge currents for each of the batteries, and the like. However, this arrangement is susceptible to misconfiguration. In instances where external BMS(s) are misconfigured, the balancing of each of the batteries of the battery bank may be incorrectly performed. Accordingly, each of the batteries of the battery bank may charge and/or discharge in a sub-optimal manner and/or may have a reduced lifespan due to the sub-optimal charging and/or discharging of each of the batteries of the battery bank.

Moreover, these external BMS(s) may be needed to enable certain configurations of multiple distinct batteries in the battery bank (e.g., generally limited to a parallel configuration or a series configuration) to enable active balancing of the batteries of the battery bank. However, when these external BMS(s) receive a signal that indicates that a charging source is available for the battery bank (e.g., a dedicated charger, another battery bank, etc.), the signal may not include any indication of a given battery, that is included in the battery bank, that should be charged. Accordingly, these external BMS(s) (i.e., which may be misconfigured) work in conjunction with corresponding internal BMS(s) to ensure proper balancing of the batteries in the battery bank.

As a result, there is a need in the art for an improved battery bank and a need in the art for techniques related to the management thereof.

### SUMMARY

Embodiments described herein relate to a battery bank and techniques for managing batteries of the battery bank. For example, the battery bank may include a primary battery and at least one secondary battery. In various embodiments, processor(s) of a primary battery management system (BMS) of the primary battery may monitor a plurality of battery diagnostic information for the battery bank, receive an indication to charge the battery bank from a central controller that is communicatively coupled to the battery bank, select a given battery to be charged from among the primary battery and the at least one secondary battery (e.g., even though the indication received from the central controller does not include any indication of the given battery to be charged), and cause the given battery to be charged. In various embodiments, the primary BMS may be internal to the primary battery. In various embodiments, the at least one secondary battery may include a corresponding secondary BMS to communicate with the primary BMS to enable the processor(s) of the primary BMS to monitor the battery diagnostic information and instruct the at least one secondary battery to be charged.

In some examples, that the battery bank may be installed in a recreational vehicle (RV) and provides power to various components of the RV (e.g., a cooling system of the RV, a lighting system of the RV, a cooking system of the RV, an entertainment system of the RV, and so on), and assume that the battery bank is communicatively coupled to a central controller of the RV (e.g., via a wired connection or a wireless connection). In this example, the processor(s) of the primary BMS may obtain the battery diagnostic information for the primary battery, and may receive, from the corresponding secondary BMS of the at least one secondary battery of the battery bank, the plurality of battery diagnostic information for the at least one secondary battery. The plurality of battery diagnostic information may be obtained and/or received in a continuous manner (e.g., receive a continuous stream of the battery diagnostic information) and/or a periodic manner (e.g., receive updated battery diagnostic information every 3 seconds, 5 seconds, 10 seconds, and/or some other periodic duration of time), and may characterize a state of the respective batteries. Accordingly, when the processor(s) of the primary BMS receives an indication from the central controller of the RV that a charging source for the battery bank is available (e.g., via a dedicated charging device, via another battery bank of the RV, and/or other sources), the processor(s) of the primary BMS may leverage the battery diagnostic information to intelligently select which battery or batteries of the battery should be prioritized in the balancing of the batteries of the battery bank, such as a given battery (or multiple given batteries) that has a lowest state of charge.

In various embodiments, the plurality of battery diagnostic information may include, for instance, a corresponding set of battery health metrics for each of the batteries of the battery bank, a corresponding set of operating parameters for each of the batteries of the battery bank, and/or any other information associated with the batteries of the battery bank. The corresponding set of battery health metrics may include, for instance, a corresponding charge cycle for a given battery of the battery bank, a corresponding discharge cycle for the given battery of the battery bank, a corresponding deepest discharge depth for the given battery of the battery bank, a corresponding average discharge depth for the given battery of the battery bank, a corresponding lowest voltage that the given battery of the battery bank has experienced, a corresponding highest discharge depth that the given battery of the battery bank has experienced, and/or other battery health metrics for the given battery of the battery bank. Further, the corresponding set of operating parameters may include, for instance, a corresponding high voltage limit for the given battery of the battery bank, a corresponding low voltage limit for the given battery of the battery bank, a corresponding maximum charge current limit for the given battery of the battery bank, a corresponding maximum discharge current limit for the given battery of the battery bank, and/or other operating parameters for the given battery of the battery bank.

In some versions of those embodiments, the battery diagnostic information for each of the batteries of the battery bank that is obtained over a duration of time may be stored in memory or a storage device of the primary BMS. This enables a human that is associated with the battery (e.g., a manufacturer) to access the battery diagnostic information that is stored in the memory or the storage device of the primary BMS. Notably, since the primary BMS is internal to the primary battery, other humans (e.g., a consumer) may not be able to access this information. Accordingly, these other humans may not be able to delete or otherwise manipulate the corresponding battery health metrics. Further, these other humans may not be able to configure or reconfigure any of the corresponding operating parameters. As a result, the battery bank may charge and/or discharge in a more optimal and reliable manner and/or may have a relatively longer lifespan due to the more optimal charging and/or discharging of each of the batteries of the battery bank as compared to existing battery systems.

In various embodiments, the processor(s) of the primary BMS may receive a corresponding message from the corresponding BMS of the at least one secondary battery. The corresponding message may include, for instance, (1) a corresponding indication of a configuration state of the at least one secondary battery; and/or (2) a corresponding unique identifier for at least one secondary battery. The corresponding indication of the configuration state of the at least one secondary battery may indicate, for instance, whether the at least one secondary battery is connected to the primary battery in a parallel configuration or a series configuration. Further, the corresponding unique identifier for at least one secondary battery may correspond to any alphanumeric string of letters and/or numbers to uniquely identify the at least one secondary battery.

In these embodiments, the processor(s) of the primary BMS may select the at least one given battery to be charged based on the various data of the plurality of battery diagnostic information for the battery bank and the corresponding message received from the at least one secondary battery. For example, assume that a battery bank of an RV includes 8 batteries configured in a parallel configuration and 4 batteries configured in a series configuration. In this example, a given battery that is directly connected to a central controller of the RV may be considered the primary battery in that it communicates with the central controller on behalf of the battery bank as a whole (e.g., the central controller may treat the battery bank as a single battery). Further, in this example, the primary battery may be assigned a corresponding unique identifier of “1”, a first secondary battery may be assigned a corresponding unique identifier of “2”, a second secondary battery may be assigned a corresponding unique identifier of “3”, and so on for the remaining secondary batteries of the battery bank. Further assume that the first secondary battery is configured in parallel with the primary battery, and further assume that the second secondary battery is configured in series with the primary battery. Moreover, in this example, the processor(s) of the primary BMS may receive a corresponding message from the first secondary battery that includes the corresponding unique identifier of “2” and the configuration status of “parallel”, and the may receive a corresponding message from the second secondary battery that includes the corresponding unique identifier of “3” and the configuration status of “series”.

Accordingly, in selecting the given battery to be charged in this example, the processor(s) of the primary BMS may also consider the corresponding unique identifiers and/or the corresponding configuration status of each of the batteries of the battery bank. Notably, batteries that are configured in parallel may all be charged by the same charging source simultaneously by virtue of the parallel configuration. However, in various embodiments the batteries that are configured in series may not be charged by the same charging source simultaneously by virtue of the series configuration. Accordingly, in this example, the processor(s) of the primary BMS may select the batteries of the battery bank to be charged from among, for instance, the 8 batteries that are configured in parallel or each of the batteries that are configured in series (or from among multiple batteries connected in a parallel manner, but in series with other batteries that are configured in a parallel manner). As a result, proper balancing of the batteries in the battery bank may be performed for a variety of different configurations of the batteries of the battery bank (e.g., different combinations of parallel and/or series configurations), rather than limiting the battery bank to parallel configurations.

In some embodiments, the corresponding messages may also be stored in the memory or the storage device of the primary BMS to index the battery diagnostic information on a battery-by-battery basis in the memory or the storage device of the primary BMS. This may help the human (e.g., the manufacturer, programmer, end user, and the like) quickly and efficiently identify the battery diagnostic information for a given battery of the battery bank (e.g., for warranty purposes, for subrogation purposes, and/or other purposes).

In various embodiments, the primary BMS may communicate with the central controller and the corresponding secondary BMS(s) using one or more communication protocols. The one or more communication protocols may include, for instance, an RV-C communications protocol, a J1939 communications protocol, a NMEA 2000 protocol, and/or other communications protocols. For example, the battery diagnostic information, the corresponding messages described, the indication to charge the battery, and/or other signals or communications described herein may be communicated using one or more of these communication protocols. These communications protocols may be utilized across any combination of wired and/or wireless communications.

In various embodiments, and subsequent to the at least one given battery being charged (and assuming that the charging source is still available) or reaching a threshold state of charge, the processor(s) of the primary BMS may select at least one other given battery to be charged that is in addition the at least one given battery that was already charged. In these embodiments, the processor(s) of the primary BMS may select the at least one other given battery to be charged based on updated battery diagnostic information and/or additional corresponding messages that are received while the at least one given battery is being charged and/or subsequent to the at least one given battery being charged. The processor(s) of the primary BMS may continue to charge the batteries of the battery bank in this manner until, for example, the charging source is no longer available or until all of the batteries of the battery bank are properly charged and balanced. However, it should be noted that the balancing of the batteries of the battery bank may be performed while charging or discharging such that the corresponding battery that was fully charged is no longer considered in the balancing until the corresponding battery is discharged and subsequently charged.

In various embodiments, each of the batteries of the battery bank (e.g., the primary battery, the at least one secondary battery, and any other secondary batteries of the battery bank) may include a corresponding heater. The corresponding heater may be utilized to maintain a temperature above a threshold while the at least one given battery (or the at least one other given battery) is being charged. In these embodiments, the corresponding heater may be activated when a temperature of the at least one given battery (or the at least one other given battery) is below a threshold to prevent the at least one given battery (or the at least one other given battery) from being damaged during charging, thereby prolonging the lifespan of the battery.

In various embodiments, and in response to a state of charge of a given battery of the battery bank (e.g., the primary battery, the at least one secondary battery, or any other secondary batteries of the battery bank) dropping below a threshold state of charge (e.g., 3%, 5%, and the like.), the processor(s) of the primary BMS and/or processor(s) of the corresponding secondary BMS may cause a corresponding discharge path of the given battery to be deactivated (e.g., by disconnecting battery cells of the given battery). This ensures that the given battery has reserve capacity in case of emergency and the given battery may be manually started by a human (e.g., the consumer, programmer, consumer, end user, and the like). However, the corresponding discharge path may be periodically activated and deactivated (e.g., every 30 seconds, 1 minute, 5 minutes, and/or the like) to detect whether a charging source for the given battery of the battery bank is available. Otherwise, a human (e.g., the consumer) may have to manually reactivate the given battery prior to the given battery being charged.

By using the techniques described herein, various technical advantages can be achieved. As one non-limiting example, techniques described herein provide improved balancing of the batteries of the battery bank, thereby prolonging the lifespan of the batteries of the battery bank. Further, techniques described herein enable the batteries to be configured in a variety of different configurations compared to known batteries, thereby expanding the applications of the battery bank while maintaining proper balancing of the batteries of the battery bank. Accordingly, techniques described herein result in an improved battery bank and management thereof.

These and additional features provided by the embodiments described herein will be more fully understood in view of the following detailed description, in conjunction with the drawings.

The above description is provided as an overview of only some embodiments disclosed herein. Those embodiments, and other embodiments, are described in additional detail herein.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a block diagram of an example hardware and software environment that demonstrates various aspects of the present disclosure, and in which embodiments disclosed herein can be implemented.

FIG. 2A schematically depicts a perspective view of a battery in accordance with various embodiments;

FIG. 2B schematically depicts a cross-sectional view of the battery enclosure of FIG. 2A taken from line XX-XX, in accordance with various embodiments;

FIG. 2C depict a perspective view of a battery in accordance with various embodiments;

FIG. 2D depicts a cross-sectional view of the battery of FIG. 2C taken from line XX-XX, in accordance with various embodiments;

FIG. 2E schematically depicts a parallel configuration of a plurality of batteries of the battery of FIG. 2A in a battery bank arrangement in accordance with various embodiments;

FIG. 2F schematically depicts a series configuration of a plurality of batteries of the battery of FIG. 2A in a battery bank arrangement in accordance with various embodiments;

FIG. 2G schematically depicts a mixed parallel and series configuration of a plurality of batteries of the battery of FIG. 2A in a battery bank arrangement in accordance with various embodiments;

FIG. 3 depicts an illustrative flowchart illustrating an example method of utilizing a primary battery management system (BMS) of a primary battery of a battery bank in selecting a given battery, included in the battery bank, to be charged, in accordance with various embodiments;

FIG. 4 depicts an illustrative flowchart illustrating an example method of utilizing a battery management system (BMS) of a battery of a battery bank in activating and/or deactivating a corresponding discharge path of the battery, in accordance with various embodiments; and

FIG. 5 schematically depicts an example architecture of a computing device, in accordance with various embodiments.

### DETAILED DESCRIPTION OF THE DRAWINGS

As used herein, the term “communicatively coupled” means that coupled components are capable of exchanging data signals and/or electric signals with one another such as, for example, electrical signals via conductive medium, electromagnetic signals via air, optical signals via optical waveguides electrical energy via conductive medium or a non-conductive medium, data signals wirelessly and/or via conductive medium or a non-conductive medium and the like.

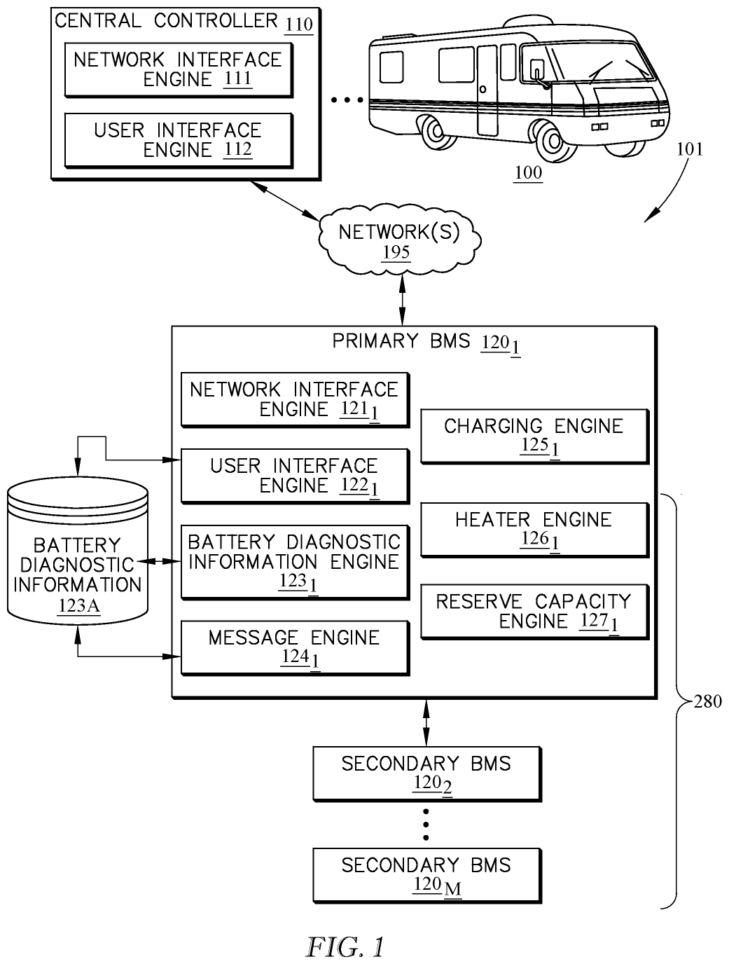

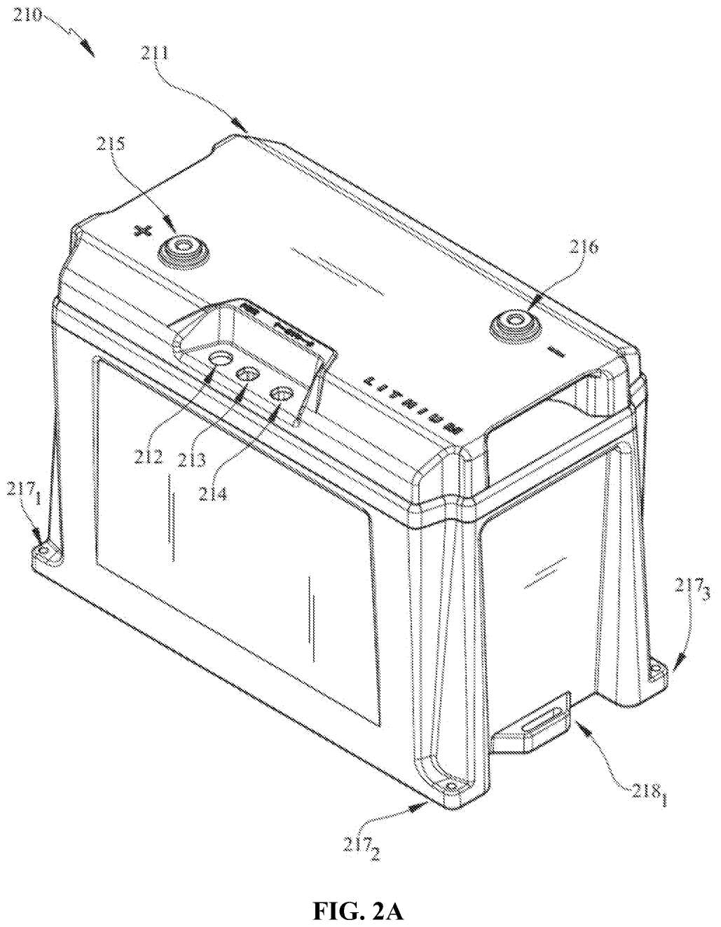

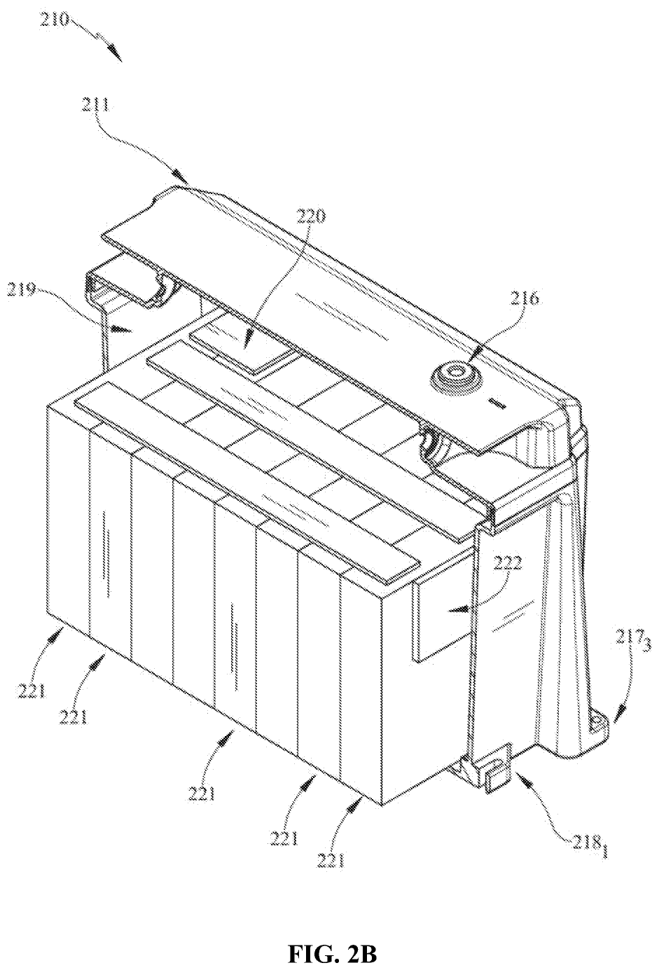

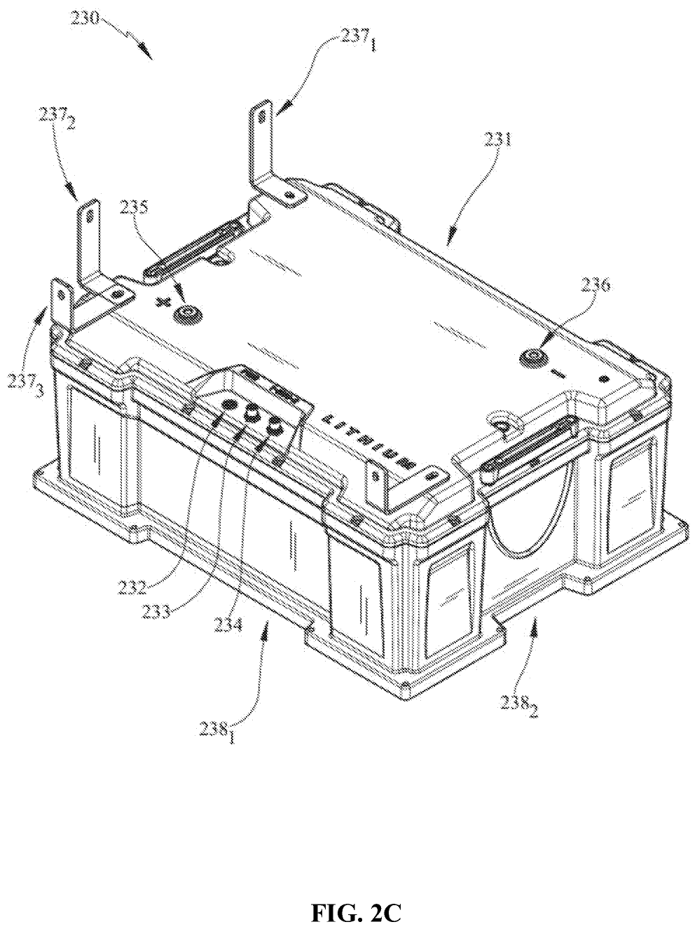

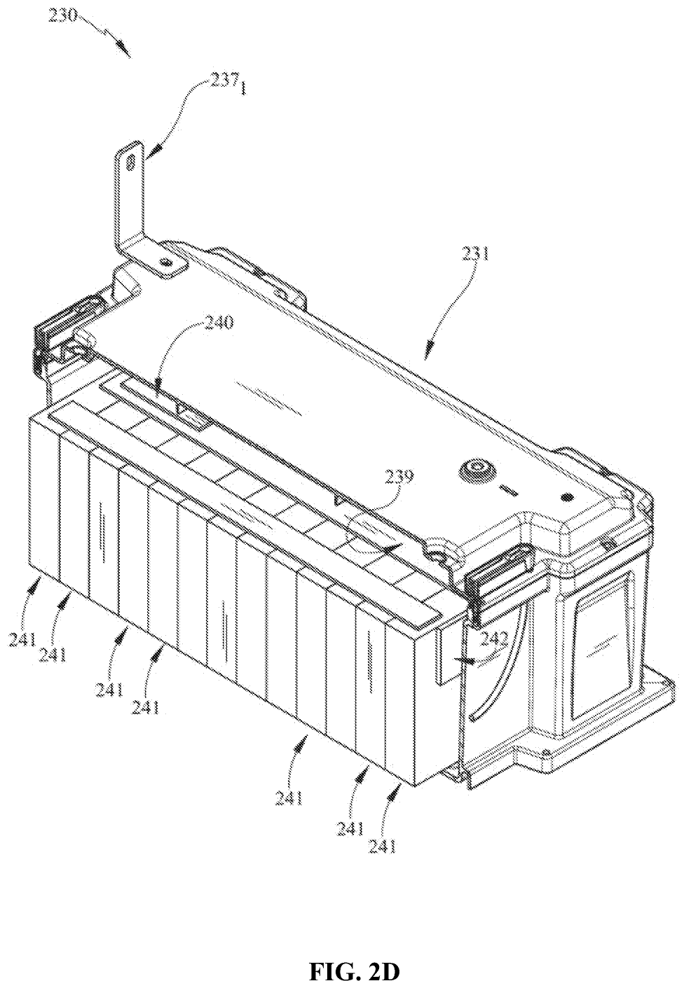

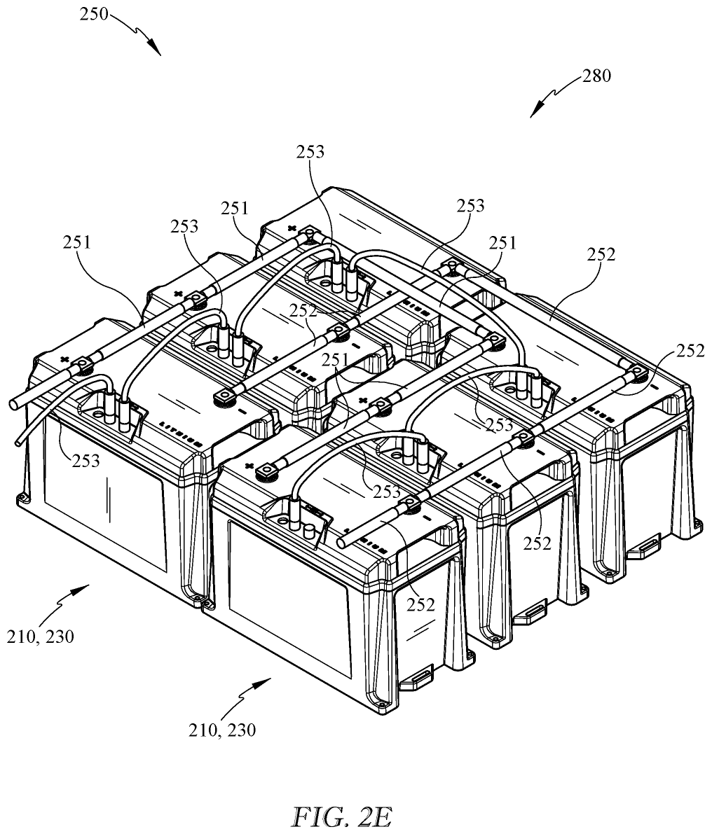

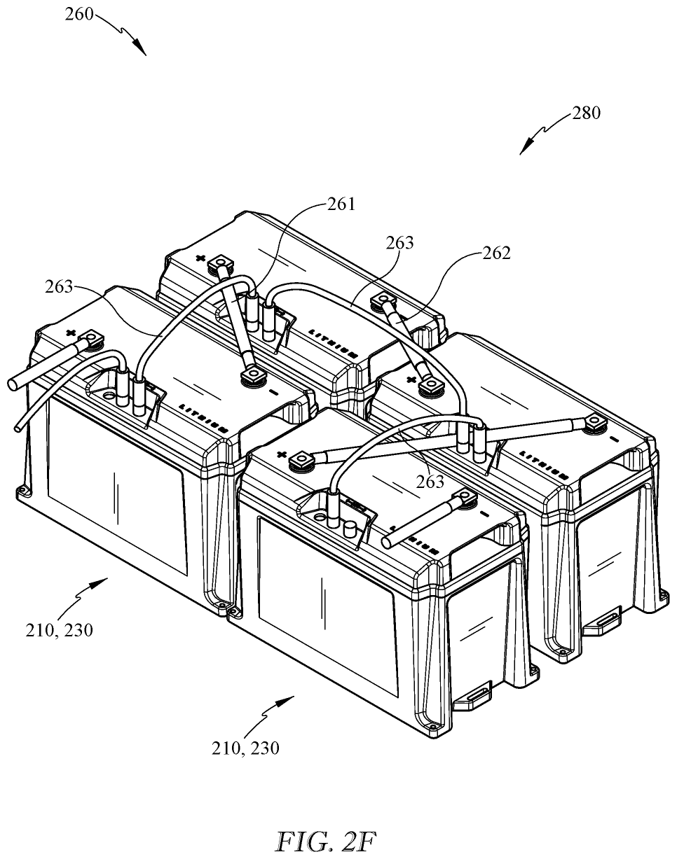

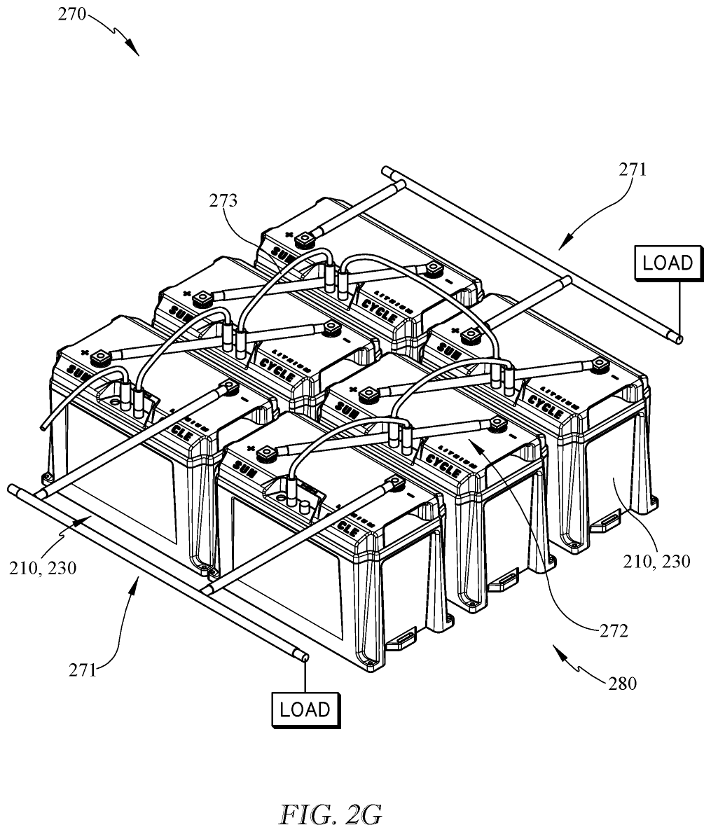

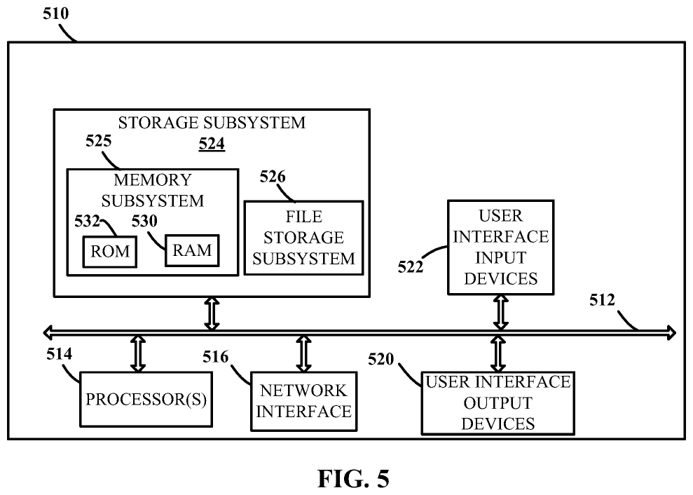

Turning now to FIG. 1, an environment 101 in which one or more selected aspects of the present disclosure may be implemented is depicted. The example environment 101 may include: a central controller 110, a primary management system (BMS) 120₁ of a primary battery of a battery bank 280, and a plurality of secondary BMS's 120₂-120_{M} of a plurality of corresponding secondary batteries of the battery bank 280 (and where M is a positive integer greater than 2), and a recreational vehicle (RV) 100. The batteries described herein may take on various forms and include various components (e.g., as described with respect to FIGS. 2A-2D). The central controller 110 may be communicatively coupled to communicate with the primary BMS 120₁, for example, through one or more networks 195 (e.g., wired or wireless networks) and using various communication protocols (e.g., RV-C, J1939, NMEA 2000). Additionally, the central controller 110 may be referred to or include the structure of the computing device 510, as discussed in more detail with respect to FIG. 5. As such, the central controller 110 (computing device 510) may be an electronic control unit (ECU), a central processing unit (CPU), and the like. Further, the primary BMS 120₁ may communicate with the plurality of secondary BMS's 120₂-120_{M} via one or more wired or wireless connections. In the example of FIG. 1, the central controller 110 may be a central controller of the RV 100 in which a battery bank 280 (e.g., that includes the primary battery and the plurality of corresponding secondary batteries) is installed.

Each of the central controller 110, the primary BMS 120₁, and the plurality of secondary BMS's 120₂-120_{M} may include one or more memories or storage devices for storing data, one or more processors for accessing the data and executing operations, and other components that facilitate communication over one or more of the networks 195. For example, the central controller 110 may include a network interface engine 111 to facilitate communication over one or more of the networks 195. Further, the central controller 110 may include a user interface engine 112 to enable a human that is associated with the RV 100 (also referred to in this context as a “user”) to interact with the central controller 110 through various interfaces and/or types of input for controlling different systems of the RV 100 (e.g., a cooling system of the RV, a lighting system of the RV, a cooking system of the RV, an entertainment system of the RV, and so on). Moreover, the primary BMS 120₁ may also include a network interface engine 1211 to facilitate communication over one or more of the networks 195. Additionally, the primary BMS 120₁ may also include a user interface engine 122₁ to enable a human that is associated with a manufacturer of one or more batteries of the battery bank (also referred to in this context as a “manufacturer”) to access data associated with the battery bank.

The primary BMS 120₁ may further include a battery diagnostic information engine 123₁, a message engine 124₁, a charging engine 125₁, a heater engine 126₁, and a reserve capacity engine 12′71. Each engine may be a module or controller that may be an electronic control unit or a central processing unit. Although the primary BMS 120₁ is depicted in FIG. 1 as including particular engines, it should be understood that is for the sake of illustrating techniques described herein and is not meant to be limiting. For instance, one or more of the engines depicted in FIG. 1 may be combined into a single engine, while others may be omitted. Further, although the plurality of secondary BMS's 120₂-120_{M} are depicted in FIG. 1 as not including any of these engines, it should be understood that is for the sake of brevity and is not meant to be limiting. For instance, each of the plurality of secondary BMS's 120₂-120_{M} may include a corresponding network interface engine, a corresponding user interface engine, a corresponding battery diagnostic information engine, a corresponding message engine, a corresponding charging engine, a corresponding heater engine, and/or a corresponding reserve capacity engine. Moreover, although the terms “primary” and “secondary” are utilized in describing the various batteries of the battery bank 280 and the corresponding BMS's of those batteries, it should be understood that these batteries may be same or substantially similar, but that the primary BMS 120₁ of the “primary” battery is utilized to communicate directly with the central controller 110 on behalf of the battery bank 280, whereas each of the plurality of “secondary” batteries may only communicate indirectly with the central controller 110 via the “primary” battery.

In various embodiments, the battery diagnostic information engine 123₁ may obtain at least one battery diagnostic information of a plurality of battery diagnostic information for the primary battery of the battery bank 280, and receive corresponding at least one battery diagnostic information of a plurality of battery diagnostic information from each of the plurality of secondary BMS's 120₂-120_{M} of the plurality of secondary batteries of the battery bank 280. In some versions of those embodiments, the battery diagnostic information may be obtained and/or received in a continuous manner (e.g., a continuous stream of plurality of battery diagnostic information), whereas in other embodiments, the plurality of battery diagnostic information may be obtained and/or received in a discrete or periodic manner (e.g., every 30 seconds, every 2 minutes, every 10 minutes, and/or the like). In some versions of those embodiments, the diagnostic information engine 123₁ may store the plurality of battery diagnostic information in memory or a storage device of the primary battery (e.g., in plurality of battery diagnostic information database 123A) to enable subsequent access to historical battery diagnostic information (e.g., by the manufacturer via the user interface engine 122₁).

In some versions of those embodiments, the plurality of battery diagnostic information may include, for instance, a corresponding set of battery health metrics for each of the batteries of the battery bank 280, a corresponding set of operating parameters for each of the batteries of the battery bank 280, and/or any other information associated with the batteries of the battery bank 280. The corresponding set of battery health metrics may include, for instance, a corresponding charge cycle for a given battery of the battery bank (e.g., the primary battery associated with the primary BMS 120₁ or one of the plurality of secondary batteries associated with a corresponding one of the plurality of secondary BMS's 120₂-120_{M}), a corresponding discharge cycle for the given battery of the battery bank, a corresponding deepest discharge depth for the given battery of the battery bank, a corresponding average discharge depth for the given battery of the battery bank, a corresponding lowest voltage that the given battery of the battery bank has experienced, a corresponding highest discharge depth that the given battery of the battery bank has experienced, and/or other battery health metrics for the given battery of the battery bank. Further, the corresponding set of operating parameters may include, for instance, a corresponding high voltage limit for the given battery of the battery bank, a corresponding low voltage limit for the given battery of the battery bank, a corresponding maximum charge current limit for the given battery of the battery bank, a corresponding maximum discharge current limit for the given battery of the battery bank, and/or other operating parameters for the given battery of the battery bank.

In various embodiments, the message engine 124₁ may receive a corresponding message from each of the plurality of secondary BMS's 120₂-120_{M} of the plurality of secondary batteries of the battery bank. The corresponding message may include, for instance, (1) a corresponding indication of a configuration state of a corresponding one of the plurality of secondary batteries of the battery bank; and/or (2) a corresponding unique identifier for the corresponding one of the plurality of secondary batteries of the battery bank. The corresponding indication of the configuration state of the at least one secondary battery may indicate, for instance, whether the corresponding one of the plurality of secondary batteries is connected to the primary battery in a parallel configuration (e.g., as described with respect to FIG. 2E) or a series configuration (e.g., as described with respect to FIG. 2F). Further, the corresponding unique identifier for the corresponding one of the plurality of secondary batteries may correspond to any alphanumeric string of letters and/or numbers to uniquely identify the at least one secondary battery.

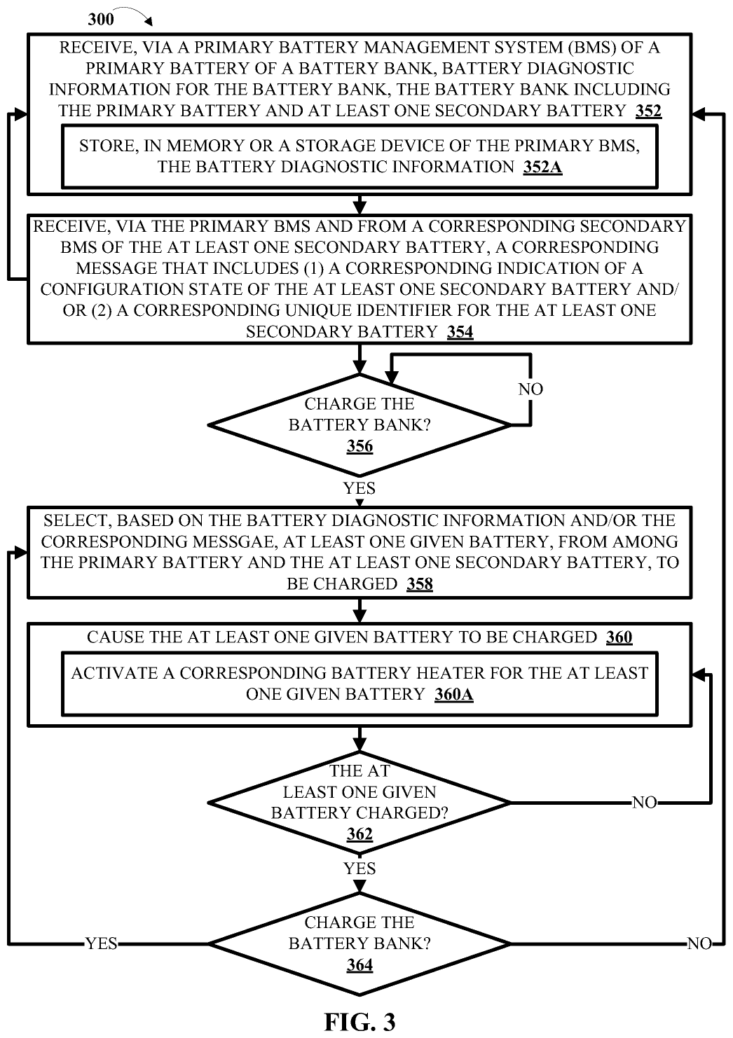

In various embodiments, the charging engine 125₁ may select, based on the plurality of battery diagnostic information obtained and/or received by the plurality of battery diagnostic information engine 123₁, and/or based on the corresponding messages received by the message engine 124₁, one or more given batteries of the battery bank to be charged in response to determining that an indication to charge the battery bank is received from the central controller 110. In some versions of those embodiments, the heater engine 126₁ may activate a corresponding heater of the one or more given batteries of the battery bank that was/were selected to be charged to prevent the one or more given batteries from being damaged. These operations are described in more detail herein (e.g., with respect to FIG. 3). In various embodiments, the reserve capacity engine 127₁ may selectively activate and/or deactivate a corresponding discharge path of one or more of the batteries to prevent the one or more given batteries from being depleted while still allowing one or more of the batteries to be utilized in emergency situations. These operations are described in greater detail herein.

Although FIG. 1 is described with respect to the central controller 110 being a central controller of the RV in which the battery bank is installed, it should be understood that this is for the sake of example and is not meant to be limiting. For example, the central controller 110 and the battery bank described herein may be employed in various other applications and implement techniques described herein. Some non-limiting examples of these applications may include, for instance, other vehicle applications (e.g., tractor-trailers, watercraft, aircraft, and/or the like), emergency power backup applications, solar power applications, surveillance or alarm system applications, and/or any other applications in which the batteries and battery banks described herein may be employed.

Turning now to FIGS. 2A-2G, various non-limiting examples of batteries and various non-limiting configurations of the batteries are depicted. Although the various non-limiting examples of batteries described with respect to FIGS. 2A-2G are lithium batteries, it should be understood that is for the sake of example and is not meant to be limiting and that other alternatives are contemplated herein, such as aluminum-based alternatives, sodium-based alternatives, iron-based alternatives, silicon-based alternatives, magnesium-based alternatives, and the like.

Referring now to FIG. 2A, a perspective view of a battery 210 is depicted. The battery 210 depicted in FIG. 2A may be a 100 Amp-hour (Ah) lithium battery (more particularly, a LiFePO4 battery, but not limited to a LiFePO4 battery). Further, the battery 210 may include a battery enclosure 211 having various components disposed on various surfaces of the battery enclosure 211. In various embodiments, a power button 212 may be disposed on a recessed top surface of the battery enclosure 211 and enable the battery 210 to be manually powered on and/or powered off by a human (e.g., the consumer and/or the manufacturer). In various embodiments, a plurality of communication ports 213, 214 may be disposed on the recessed top surface of the battery enclosure 211 proximate to the power button 212 to enable the battery 210 to be communicatively coupled to various external systems (e.g., communicatively coupled to the central controller 110 of FIG. 1 via one of the plurality of communication ports 213, 214) and/or additional instance(s) of the battery (e.g., communicatively coupled to an additional instance of the battery 210 via another one of the plurality of communication ports 213, 214 to form a battery bank having at least two batteries). Additionally, or alternatively, the plurality of communication ports 213, 214 may enable the battery 210 to be communicatively coupled to multiple additional instances of the battery (e.g., communicatively coupled to a first additional instance of the battery 210 via one of the plurality of communication ports 213, 214, and communicatively coupled to a second additional instance of the battery 210 via another one of the plurality of communication ports 213, 214 to form a battery bank having at least three batteries).

In various embodiments, the battery 210 may include a plurality of battery terminals 215, 216 disposed on a top surface of the battery enclosure 211. For example, a first battery terminal 215, of the plurality of battery terminals 215, 216, may be a positive terminal, and a second battery terminal 216, of the plurality of battery terminals 215, 216, may be a negative terminal. In the illustrated embodiment, and as shown in FIG. 2A, the plurality of terminals 215, 216 may be staggered in that they are not on the same plane on the top surface of the battery enclosure 211. The staggered nature of the plurality of battery terminals 215, 216 enables batteries of a battery bank to be configured in a parallel configuration (e.g., as described with respect to FIGS. 2E and 2G) and/or a series configuration (e.g., as described with respect to FIGS. 2F and 2G) with minimal interference between wired connections in making these different configurations. This is non-limiting and the battery terminals 215, 216 may be in any arrangement. Further, the plurality of battery terminals 215, 216 may include various markings and/or indicators (e.g., word markings and/or indicators directly on the battery 210, additional components that may be affixed to the battery 210, and so on) to reduce the likelihood of connecting the batteries in reverse polarity.

In various embodiments, the battery enclosure 211 may include a plurality of mounting features 217₁, 217₂, 217₃, and optionally other mounting features that are not depicted. For example, in the depicted embodiment and as shown in FIG. 2A, the plurality of mounting features 217₁, 217₂, 217₃ may include integrated screw holes that are disposed on a recessed bottom surface of the battery enclosure 211. In this example, the plurality of mounting features 217₁, 217₂, 217₃ enable the battery 210 to be quickly and efficiently mounted onto various other surfaces when the battery 210 is installed for a particular application. In various embodiments, the battery enclosure 211 may include a tab 2181 and optionally other tabs that are not depicted. For example, and as shown in FIG. 2A, the tab 2181 ensures that when the battery 210 is installed for the particular application that the battery 210 is installed with an air gap for cooling purposes. Although the perspective view of the battery 210 depicts certain features and is described as a 100 Ah lithium battery, it should be understood that is for the sake of example and is not meant to be limiting, and that the battery 210 may omit some of the components described with respect to FIG. 2A and/or include additional components that are not depicted in FIG. 2A.

Referring now to FIG. 2B, a cross-sectional view of the battery 210 from FIG. 2A is depicted. In various embodiments, the battery enclosure 211 may include a battery cavity 219 disposed within the battery enclosure 211. The battery cavity 219 may include a battery management system (BMS) 220, a plurality of battery cells 221 (e.g., two or more), and a battery heater 222 disposed within the battery cavity 219. As depicted, the BMS 220 is internal to the battery enclosure 211, but is external to the plurality of battery cells 221. This may prevent some humans (e.g., the consumer) from accessing the BMS 220, but may enable other humans (e.g., the manufacturer) to access the BMS 220 (e.g., via removing a top of the battery enclosure 211). Further, as noted herein, chemistry of the plurality battery cells 221 are described herein as lithium batteries, but other battery chemistries are contemplated herein. Functionality of the BMS 220 and the battery heater 222 is described in greater detail herein. Although the battery 210 is depicted in FIG. 2A as having 8 battery cells as the plurality of battery cells 221, it should be understood that is for the sake of example and is not meant to be limiting and that other quantities of battery cells may be utilized to achieve the 100 Ah lithium battery.

Referring now to FIG. 2C, a perspective view of an additional battery 230 is depicted. The battery 230 depicted in FIG. 2C may be a 300 Amp-hour (Ah) lithium battery. Further, the battery 230 may include a battery enclosure 231 having various components disposed on various surfaces of the battery enclosure 231. In various embodiments, a power button 232 may be disposed on a recessed top surface of the battery enclosure 231 and enable the battery 230 to be manually powered on and/or powered off by a human (e.g., the consumer and/or the manufacturer). In various embodiments, a plurality of communication ports 233, 234 may be disposed on the recessed top surface of the battery enclosure 231 proximate to the power button 232 to enable the battery 230 to be communicatively coupled to various external systems (e.g., communicatively coupled to the central controller 110 of FIG. 1 via one of the plurality of communication ports 233, 234) and/or additional instance(S) of the battery (e.g., communicatively coupled to an additional instance of the battery 230 via another one of the plurality of communication ports 233, 234 to form a battery bank having at least two batteries). Additionally, or alternatively, the plurality of communication ports 233, 234 may enable the battery 230 to be communicatively coupled to multiple additional instances of the battery (e.g., communicatively coupled to a first additional instance of the battery 230 via one of the plurality of communication ports 233, 234, and communicatively coupled to a second additional instance of the battery 230 via another one of the plurality of communication ports 233, 234 to form a battery bank having at least three batteries).

In various embodiments, the battery 230 may include a plurality of battery terminals 235, 236 disposed on a top surface of the battery enclosure 231. For example, a first battery terminal 235, of the plurality of battery terminals 235, 236, may be a positive terminal, and a second battery terminal 236, of the plurality of battery terminals 235, 236, may be a negative terminal. In the depicted embodiment of FIG. 2C, the plurality of terminals 235, 236 may be staggered in that they are not on the same plane on the top surface of the battery enclosure 231. The staggered nature of the plurality of battery terminals 235, 236 enables batteries of a battery bank to be configured in a parallel configuration (e.g., as described with respect to FIGS. 2E and 2G) and/or a series configuration (e.g., as described with respect to FIGS. 2F and 2G) with minimal interference between wired connections in making these different configurations. This is non-limiting and the battery terminals 235, 236 may be in any arrangement.

In various embodiments, the battery enclosure 231 may include a plurality of mounting features 2371, 2372, 2373 and optionally other mounting features that are not depicted. For example, in the depicted embodiment, the plurality of mounting features 2371, 2372, 2373 may include mounting brackets that are disposed on the top surface of the battery enclosure 231. In this example, the plurality of mounting features 2371, 2372, 2373 enable the battery 230 to be quickly and efficiently mounted onto various other surfaces when the battery 230 is installed for a particular application. In various embodiments, the battery enclosure 231 may include a plurality of air gaps 2381, 2382, and optionally other air gaps that are not depicted for cooling purposes. Although the perspective view of the battery 230 depicts certain features and is described as a 300 Ah lithium battery, it should be understood that is for the sake of example and is not meant to be limiting, and that the battery 230 may omit some of the components described with respect to FIG. 2C and/or include additional components that are not depicted in FIG. 2C.

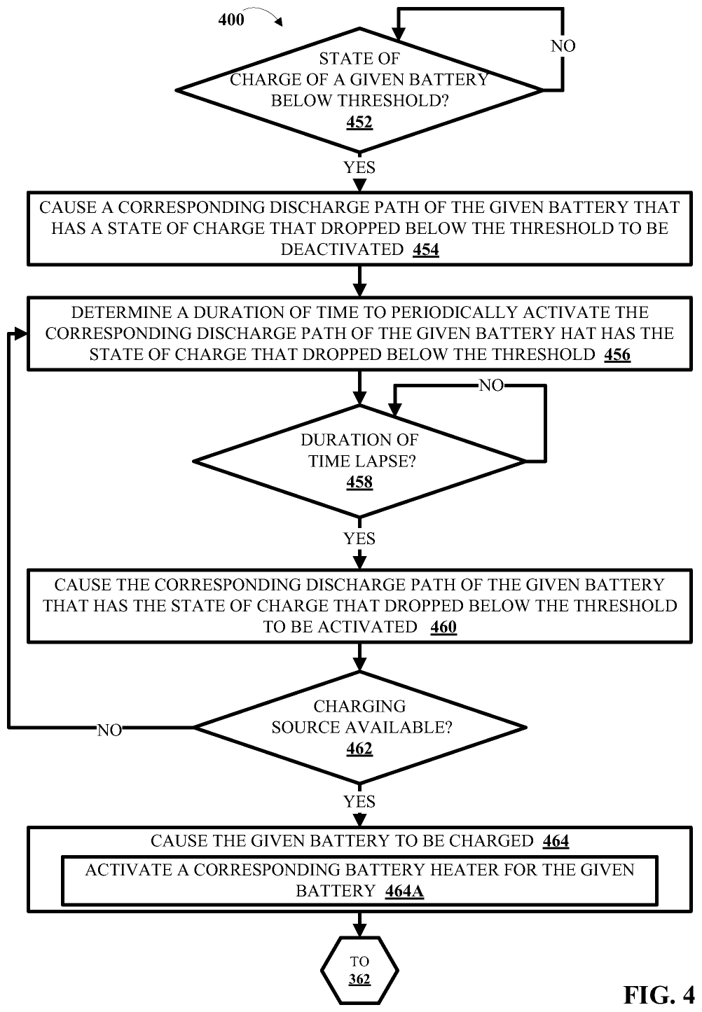

Referring now to FIG. 2D, a cross-sectional view of the battery 230 from FIG. 2C is depicted. In various embodiments, the battery enclosure 231 may include a battery cavity 239 disposed within the battery enclosure 231. The battery cavity 239 may include a battery management system (BMS) 240, a plurality of battery cells 241 (e.g., two or more), and a battery heater 242 disposed within the battery cavity 239. The BMS 240 may be internal to the battery enclosure 231, but external to the plurality of battery cells 241. This may prevent some humans (e.g., the consumer) from accessing the BMS 240, but may enable other humans (e.g., the manufacturer) to access the BMS 240 (e.g., via removing a top of the battery enclosure 231). Further, as noted herein, chemistry of the plurality battery cells 241 are described herein as lithium batteries, but other battery chemistries are contemplated herein. Functionality of the BMS 240 and the battery heater 242 is described in greater detail herein (e.g., with respect to FIGS. 3 and 4). Although the battery 210 is depicted in FIG. 2D as having 13 battery cells as the plurality of battery cells 241, it should be understood that is for the sake of example and is not meant to be limiting and that other quantities of battery cells may be utilized to achieve the 300 Ah lithium battery.

Referring now to FIG. 2E, the battery 210 from FIG. 2A is schematically depicted as a bank 280 of a plurality of batteries 210 in a parallel configuration 250. In the parallel configuration 250, the positive terminals of each of the batteries 210 are connected via positive terminal wiring 251 and the negative terminals of each of the batteries 210 are connected via negative terminal wiring 252. Further, in the parallel configuration 250, each of the batteries 210 are communicatively coupled via communication wiring 253 between the communication ports of each of the batteries. In the example depicted in FIG. 2E, the parallel configuration corresponds to a battery bank 280 having six batteries in the parallel configuration 250, where a terminal battery in the parallel configuration 250 is a primary battery and the other five batteries in the parallel configuration 250 are secondary batteries. Moreover, and assuming that each of the instances of the battery 210 from FIGS. 2A and 2B are 100 Ah batteries, the battery bank would have a capacity of 600 Ah at a constant voltage (e.g., 12 V, 24 V, 36V, 48V etc., which is based on the voltage of the battery 210), and the capacity of the battery bank may be increased in an additive manner by adding more instances of the battery 210 in parallel (e.g., an additional 100 Ah for each instance of the battery 210 added in parallel). In contrast, if the parallel configuration 250 depicted in FIG. 2E included a plurality of instances of the battery 230 from FIGS. 2C and 2D, and assuming that each of the instances of the battery 230 from FIGS. 2C and 2D are 300 Ah batteries, the battery bank would have a capacity of 1,800 Ah at a constant voltage (e.g., 12 V, 24 V, 36V, etc., which is based on the voltage of the battery 230), and the capacity of the battery bank may be increased in an additive manner by adding more instances of the battery 230 in parallel (e.g., an additional 300 Ah for each instance of the battery 230 added in parallel). However, since the battery bank 280 has a constant voltage in the parallel configuration 250 and a larger capacity, the battery bank 280 depicted in FIG. 2E may have a higher current draw and higher voltage drop, which may cause the battery bank 280 to operate in a less efficient manner when operating at lower voltages. Lastly, in the parallel configuration 250 depicted in FIG. 2E, each of the batteries 210 of the battery bank 280 may be charged simultaneously from a single charging source.

Referring now to FIG. 2F, a plurality of instances of the battery 210 from FIGS. 2A is and 2B are schematically depicted as a battery bank 280 of a plurality of batteries in a series configuration 260. Notably, in the series configuration 260, the negative terminal of the primary battery is connected to the positive terminal of a secondary battery via wiring 261, the negative terminal of the secondary battery is connected to the positive terminal of an additional secondary battery via wiring 262, and so on for each of the remaining batteries of the battery bank. Further, in the series configuration 260, each of the batteries are communicatively coupled via communication wiring 263 between the communication ports of each of the batteries 210. In the example depicted in FIG. 2F, the series configuration corresponds to a battery bank 280 having four batteries in the series configuration 260, where a terminal battery in the series configuration 260 is a primary battery and the other three batteries in the series configuration 260 are secondary batteries. Further, and assuming that each of the instances of the battery 210 from FIGS. 2A and 2B are 100 Ah batteries, the battery bank 280 would have a capacity of 100 Ah at a varying voltage (e.g., 12 V, 24 V, 36V, 48V etc., which is based on the voltage of the battery 210 and a number of the batteries connected in the series configuration 260), and the voltage of the battery bank may be increased in an additive manner by adding more instances of the battery 210 in series. In contrast, if the series configuration 260 depicted in FIG. 2F included a plurality of instances of the battery 230 from FIGS. 2C and 2D, and assuming that each of the instances of the battery 230 from FIGS. 2C and 2D are 300 Ah batteries, the battery bank would have a capacity of 300 Ah at the varying voltage (e.g., 12 V, 24 V, 36V, etc., which is based on the voltage of the battery 230), and the voltage of the battery bank may be increased in an additive manner by adding more instances of the battery 230 in series. However, since the battery bank has a constant capacity in the series configuration 260 and larger voltage, the battery bank depicted in FIG. 2F may have to interface with various other components (e.g., a converter) to enable certain devices to be powered by the battery bank (e.g., appliances of the RV 100 of FIG. 1 that utilize 12V).

Lastly, in the series configuration 260 depicted in FIG. 2F, and in contrast with the parallel configuration 250 depicted in FIG. 2E, each of the batteries 210 may only be charged simultaneously from a single charging source if the single charging source supports the voltage of the battery bank in the series configuration. For instance, if a given battery bank includes three 12V batteries connected in series (i.e., resulting in a 36V battery bank), but the single charging source only supports 12V in charging, then only one of the batteries may be charged simultaneously. However, if the single charging source supports 24V in charging, then two of the batteries may be charged simultaneously. Further, if the single charging source supports 36V in charging, then all three of the batteries may be charged simultaneously.

Put another way, in the parallel configuration 250 of FIG. 2E, the battery bank 280 may have a higher capacity, but a lower voltage. In contrast, in the series configuration 260 of FIG. 2F, the battery bank may have a lower capacity, but a higher voltage. Accordingly, in various applications, it may be advantageous to have a battery bank that has some batteries configured in a parallel configuration (e.g., as described with respect to FIG. 2E) and some batteries configured in a series configuration (e.g., as described with respect to FIG. 2F). Referring specifically to FIG. 2G, a plurality of instances of the battery 210 from FIGS. 2A and 2B are depicted in a mixed configuration 270 that includes some instances of the battery 210 in a parallel configuration and other instances of the battery 210 in a series configuration. For example, the mixed configuration in FIG. 2G includes two strings of three batteries connected in series configuration via series wiring 272, and the two strings of the three batteries connected in a parallel configuration via parallel wiring 271. Notably, all of the batteries 210 are communicatively coupled via communication wiring 273. This enables the battery bank 280 to simultaneously have a higher capacity for some applications, and a higher voltage for other applications. However, balancing the batteries in these mixed configurations may be more complex than simply balancing the batteries in the parallel configuration 250 depicted in FIG. 2E (e.g., as described with respect to FIG. 3).

Although FIGS. 2A-2G depict particular batteries and a particular number of batteries having particular configurations, it should be understood that this is for the sake of example and is not meant to be limiting. Rather, it should be understood that the particular batteries and particular configurations are depicted to illustrate various techniques described herein. For instance, additional batteries may be added to the stings of three batteries in series and/or additional strings of additional batteries may be added in parallel. Additionally, or alternatively, some batteries may be omitted from the strings in series to achieve different voltages and capacities for the battery bank in the mixed configuration 270.

Turning now to FIG. 3, an illustrative flowchart illustrating an example method 300 of utilizing a primary battery management system (BMS) of a primary battery of a battery bank in selecting a given battery, included in the battery bank, to be charged is depicted. For convenience, the operations of the method 300 are described with reference to a system that performs the operations. This system of the method 300 includes at least one processor, at least one memory, and/or other component(s) of computing device(s) (e.g., primary battery BMS 120₁ of FIG. 1, computing device 510 of FIG. 5, and/or other computing devices). Moreover, while operations of the method 300 are shown in a particular order, this is not meant to be limiting. One or more operations may be reordered, omitted, and/or added.

At block 352, the system receives, via a primary battery management system (BMS) of a primary battery of a battery bank, the plurality of battery diagnostic information for the battery bank, the battery bank including the primary battery and at least one secondary battery. The plurality of battery diagnostic information may include, for each battery of the battery bank, a corresponding set of battery health metrics and/or a corresponding set of operating metrics (e.g., as described with respect to the plurality of battery diagnostic information engine 123₁ of FIG. 1). In some embodiments, and as indicated at block 352A, the system may store, in memory or a storage device of the primary BMS, the battery diagnostic information (e.g., as described with respect to the plurality of battery diagnostic information engine 123₁ of FIG. 1).

At block 354, the system receives, via the primary BMS and from a corresponding secondary BMS of the at least one secondary battery, a corresponding message that includes (1) a corresponding indication of a configuration state of the at least one secondary battery and/or (2) a corresponding unique identifier for the at least one secondary battery (e.g., as described with respect to the message engine 124₁ of FIG. 1). In some embodiments, the system may store, in the memory or the storage device of the primary BMS, the corresponding message (e.g., as described with respect to the battery message engine 124₁ of FIG. 1). Notably, the system may return from block 354 to block 352. This enables the system to continually monitor the plurality of battery diagnostic information for the battery bank and receive additional corresponding messages while performing the remaining operations of the method 300 of FIG. 3.

At block 356, the system determines whether to charge the battery bank. For example, the system may determine whether to charge the battery bank based on receiving, from a central controller (e.g., the central controller 110 of FIG. 1) that is communicatively coupled to the battery bank (e.g., via a wired connection or a wireless connection), an indication to charge the battery bank. However, the indication to charge the battery bank may not include any indication of which battery (e.g., the primary battery or the at least one secondary battery) to charge in the battery bank. In this example, the system may receive the indication to charge the battery bank based on the central controller determining that a charging source is available for charging the battery bank. The charging source may include, for instance, a dedicated charging unit for the battery bank or another battery bank that is in addition to the battery bank.

If, at an iteration of block 356, the system determines not to charge the battery bank, then the system may perform additional iterations of block 356 until it is determined at a given iteration of block 356 to charge the battery bank. Notably, while the system continues to perform the additional iterations of block 356 until it is determined at the given iteration of block 356 to charge the battery bank, the system may continually monitor the plurality of battery diagnostic information for the battery bank and receive the additional corresponding messages as described above with respect to blocks 352 and 354. If, at an iteration of block 356, the system determines to charge the battery bank, then the system may proceed to block 358.

At block 358, the system selects, based on the plurality of battery diagnostic information and/or the corresponding message, at least one given battery, from among the primary battery and the at least one secondary battery, to be charged (e.g., via the charging engine 125₁ of FIG. 1). By selecting the at least one given battery based on the plurality of battery diagnostic information and/or the corresponding message, the system seeks to balance the battery bank. For instance, in a non-limiting example, the battery bank includes four batteries configured in a parallel manner, and four additional batteries configured in a parallel manner that are configured with the other four batteries in a series manner. Put another way, the battery bank may consist of two series strings of batteries that each include three batteries, and the two series strings of batteries may be configured in parallel (e.g., as described with respect to the mixed configuration 270 of FIG. 2G). The system may know, for example by a stored look-up table, this configuration of the batteries based on the corresponding messages received from the batteries of the battery bank. In this instance, the system may select which battery or string of batteries (e.g., a first string of the three batteries or a second string of three batteries) are to be charged based on state of charge information for each of the batteries. Accordingly, if a given series string of the two series strings includes batteries with a lowest state of charge, then the system may select the given series string of batteries to be charged to ensure that the two series strings of batteries are balanced.

At block 360, the system causes the at least one given battery to be charged. For example, the system may cause the at least one given battery to be connected to the charging source that is available to cause the at least one given battery to be charged. In some embodiments, and as indicated at block 360A, the system may activate a corresponding battery heater for the at least one given battery (e.g., via the heater engine 126₁ of FIG. 1). For example, the may activate the corresponding battery heater for the at least one given battery in response to determining that a temperature of the at least one given battery is below a temperature threshold. In these embodiments, the at least one given battery may not be charged (even if the charging source is available) until the temperature of the at least one given battery is above the temperature threshold to minimize instances of damaging the battery during charging due to the temperature of the at least one given battery being below the temperature threshold.

At block 362, the system determines whether the at least one given battery is charged. The system may determine that the at least one given battery is charged in response to determining that the at least one given battery is fully charged, or in response to determining that the at least one given battery has a threshold state of charge (e.g., less than fully charged). If, at an iteration of block 362, the system determines that the at least one given battery is not charged, then the system may return to block 360 and continue to cause the at least one given battery to be charged. If, at an iteration of block 362, the system determines that the at least one given battery is charged, then the system may proceed to block 364.

At block 364, the system determines whether to continue charging the battery bank. The system may determine to continue charging the battery bank based on the charging source still being available, based on the plurality of battery diagnostic information that is continually monitored indicating that additional batteries of the battery bank still need to be charged, and/or based on the additional corresponding messages received. If, at an iteration of block 364, the system determines to continue charging the battery bank, then the system may return to block 358 and select, based on the plurality of battery diagnostic information and/or the corresponding message, at least one given additional battery, from among the primary battery and the at least one secondary battery, to be charged. The system may proceed with the method 300 with respect to the at least one given additional battery. Since the at least one given battery may only be charged to the threshold state of charge (e.g., less than fully charged), the system may switch between charging different given batteries of the battery bank is a quick and efficient manner, thereby resulting in improved balancing of the batteries of the battery bank.

If, at an iteration of block 364, the system determines not to continue charging the battery bank, then the system may return to block 352 to perform an additional iteration of the method 300 of FIG. 3. The system may determine to not continue charging the battery bank based on the charging source no longer being available and/or based on the plurality of battery diagnostic information that is continually monitored indicating that no additional batteries need to be charged.

Turning now to FIG. 4, a flowchart illustrating an example method 400 of utilizing a battery management system (BMS) of a battery of a battery bank in activating and/or deactivating a corresponding discharge path of the battery is depicted. For convenience, the operations of the method 400 are described with reference to a system that performs the operations. This system of the method 400 includes at least one processor, at least one memory, and/or other component(s) of computing device(s) (e.g., primary battery BMS 120₁ of FIG. 1, one or more secondary battery BMS's 120_{M} of FIG. 1, computing device 510 of FIG. 5, and/or other computing devices). Moreover, while operations of the method 400 are shown in a particular order, this is not meant to be limiting. One or more operations may be reordered, omitted, and/or added.

At block 452, the system determines whether a state of charge of a given battery is below a threshold state of charge. The state of charge of the given battery may be included in, for example, the plurality of battery diagnostic information (e.g., as described with respect to the plurality of battery diagnostic information engine 123₁ of FIG. 1). If, at an iteration of block 452, the system determines that the state of charge of the given battery is not below the threshold state of charge, then the system may continually monitor whether the state of charge of the given battery is below the threshold state of charge at additional iterations of block 452. If, at an iteration of block 452, the system determines that the state of charge of the given battery is below the threshold state of charge, then the system may proceed to block 454.

At block 454, the system causes a corresponding discharge path of the given battery that has a state of charge that dropped below the threshold state of charge to be deactivated (e.g., via the reserve capacity engine 127₁ of FIG. 1). By deactivating the corresponding discharge path of the given battery, other batteries of the battery bank may continue operation as normal while simultaneously preventing the given battery from being depleted and shortening the lifespan of the given battery. This allows any remaining charge of the given battery to be utilized in emergency situations.

At block 456, the system determines a duration of time to periodically activate the corresponding discharge path of the given battery that has the state of charge that dropped below the threshold state of charge. At block 458, the system determines whether the duration of time has lapsed. If, at an iteration of block 458, the system determines that the duration of time has not lapsed, then the system may continually monitor whether the duration of time has lapsed at additional iterations of block 458. If, at an iteration of block 458, the system determines that the duration of time has lapsed, then the system may proceed to block 460. At block 460, the system causes the corresponding discharge path of the given battery that has the state of charge below the threshold to be activated. At block 462, the system determines whether there is a charging source available. If, at an iteration of block 462, the system determines that there is no charging source available, then the system returns to block 456. If, at an iteration of block 462, the system determines that there is a charging source available, then the system proceeds to block 464.

Put another way, the system may periodically activate the corresponding discharge path that was deactivated each time that the duration of time lapses to ensure that the given battery may detect that a charging source is available. In some embodiments, the duration of time intervals may be static (e.g., every 30 seconds, every 1 minute, every 5 minutes, and/or the like). In additional or alternative embodiments, the duration of time may be dynamic and based on the state of charge of the battery than dropped by the threshold state of charge. For example, when the corresponding discharge path of the given battery was deactivated when the given battery dropped below an 8% state of charge. In this example, the duration of time may be 30 seconds. However, if the given battery drops below a 5% state of charge, then the duration of time may be raised to 5 minutes to avoid negatively impacting the state of charge of the given battery any further.

At block 464, the system causes the given battery to be charged. In some embodiments, and as indicated at block 464A, the system may activate a corresponding battery heater for the given battery. For example, the may activate the corresponding battery heater for the at least one given battery in response to determining that a temperature of the at least one given battery is below a temperature threshold. In these embodiments, the at least one given battery may not be charged (even if the charging source is available) until the temperature of the at least one given battery is above the temperature threshold to minimize instances of damaging the battery during charging due to the temperature of the at least one given battery being below the temperature threshold. The system may proceed to block 362 of the method 300 of FIG. 3 and continue charging the battery bank.

The operations of the method 400 of FIG. 4 may be performed by a primary BMS of a primary battery of the battery bank, a corresponding secondary BMS of a corresponding secondary battery of the battery bank, or both. Put another way, the operations of the method 400 of FIG. 4 may be performed at the battery bank level or at the individual battery level to ensure that each of the batteries of the battery bank maintain some reserve capacity. Otherwise, a human (e.g., the consumer) may have to manually start and/or charge the given battery in instances where no reserve capacity is maintained and/or in instances where the given battery does not periodically activate the corresponding discharge path that was deactivated to maintain the reserve capacity.

Turning now to FIG. 5, a block diagram of an example computing device 510 that may optionally be utilized to perform one or more aspects of techniques described herein is depicted. In some embodiments, one or more BMS's (e.g., the primary battery BMS 120₁ of FIG. 1, one or more of the secondary battery BMS's 120_{M} of FIG. 1, the central controller 110 of FIG. 1), one or more vehicles, and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain embodiments may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative embodiments of the bus subsystem 512 may use multiple busses.

Computing device 510 can be of varying types including a workstation, server, electronic control unit, central processing unit (CPU), computing cluster, blade server, server farm, or any other data processing system or computing device. Due to the ever-changing nature of computers and networks, the description of computing device 510 depicted in FIG. 5 is intended only as a specific example for purposes of illustrating some embodiments. Many other configurations of computing device 510 are possible having more or fewer components than the computing device depicted in FIG. 5.

In some embodiments, a method implemented by one or more processors of a primary battery management system (BMS) of a primary battery of a battery bank is provided, and includes monitoring at least one of the plurality of battery diagnostic information for the battery bank. The battery bank including the primary battery and a plurality of secondary batteries. The method further includes receiving, from a central controller, an indication to charge the battery bank; and in response to receiving the indication to charge the battery bank: selecting, based on at least the battery diagnostic information for the battery bank, a given battery, from among the primary battery and the plurality of secondary batteries, to be charged; and causing the given battery to be charged.

These and other embodiments of technology disclosed herein can optionally include one or more of the following features.

In some embodiments, the indication to charge the battery bank may not provide any indication of the given battery to be charged.

In some embodiments, the primary BMS of the primary battery may be internal to the primary battery. In some versions of those embodiments, each of the plurality of secondary batteries may include a corresponding secondary BMS that is internal to a corresponding one of the plurality of secondary batteries.

In some further versions of those embodiments, the primary BMS of the primary battery may be communicatively coupled to each of the corresponding secondary BMS' of the plurality of secondary batteries. In yet further versions of those embodiments, the primary battery and at least one secondary battery, of the plurality of secondary batteries, may be configured in a parallel configuration via corresponding staggered battery terminals. In even yet further versions of those embodiments, the primary battery and at least one additional secondary battery, of the plurality of secondary batteries and that is in addition to the at least one secondary battery, may be configured in a series configuration via the corresponding staggered battery terminals.

In additional or alternative further versions of those embodiments, the primary BMS of the primary battery may communicate with each of the corresponding secondary BMS' of the plurality of secondary batteries using an RV-C communications protocol, a J1939 communications protocol, or a NMEA 2000 communications protocol.

In additional or alternative further versions of those embodiments, the plurality of battery diagnostic information for the battery bank may include one or more of: a corresponding set of battery health metrics for the primary battery and for each of the plurality of secondary batteries, or a corresponding set of operating parameters for the primary battery and for each of the plurality of secondary batteries. In even yet further versions of those embodiments, the plurality of battery diagnostic information may be communicated to the primary BMS of the primary battery and from the corresponding secondary BMS of each of the plurality of secondary batteries.

In additional or alternative further versions of those embodiments, the method may further include receiving, from the corresponding secondary BMS of each of the plurality of secondary batteries, a message that includes (1) a corresponding indication of a configuration status of each of the plurality of secondary batteries, and (2) a corresponding unique identifier of each of the plurality of secondary batteries. In even yet further versions of those embodiments, selecting the given battery to be charged may be further based on the message received from each of the plurality of secondary batteries.

In some embodiments, the method may further include continued monitoring at least one of the plurality of battery diagnostic information for the battery bank; and in response to determining that the given battery is charged: selecting, based on at least the plurality of battery diagnostic information for the battery bank, an additional given battery, from among the primary battery and the plurality of secondary batteries and that is in addition to the given battery, to be charged; and causing the additional given battery to be charged.

In some embodiments, the method may further include storing, in memory of the primary BMS of the primary battery, the plurality of battery diagnostic information for the battery bank over a duration of time; and enabling a user to access the plurality of battery diagnostic information for the battery bank over the duration of time.

In some embodiments, a system of batteries for a recreational vehicle (RV) is provided and includes at least a primary battery and a secondary battery. The primary battery includes a primary battery enclosure including at least a primary battery cavity, a plurality of primary battery communication ports, and a plurality of primary battery terminals; a plurality of primary battery cells that are contained within the primary battery cavity of the primary battery enclosure; and a primary battery management system (BMS) that is contained within the primary battery cavity of the primary battery enclosure, wherein the primary battery BMS includes one or more primary battery BMS processors and primary battery BMS memory. The secondary battery includes a secondary battery enclosure including at least a secondary battery cavity, a plurality of secondary battery communication ports, and a plurality of secondary battery terminals; a plurality of secondary battery cells that are contained within the secondary battery cavity of the secondary battery enclosure; and a secondary battery BMS that is contained within the secondary battery cavity of the secondary battery enclosure and that includes at least one or more secondary battery BMS processors and secondary battery BMS memory. Each the plurality of secondary battery terminals is connected to a corresponding the plurality of primary battery terminals in manner that enables the secondary battery and the primary battery in a parallel configuration or in a series configuration. Further, the one or more primary BMS processors are configured to perform operations stored in the primary BMS memory, the operations including monitoring, based on communication between the primary battery and the secondary battery via the plurality of primary battery communication ports and the plurality of secondary battery communication ports, plurality of battery diagnostic information for at least the primary battery and the secondary battery; receiving, from a central controller of the RV, an indication to charge a battery of the RV, wherein the indication to charge the battery of the RV does not identify the primary battery or the secondary battery; and in response to receiving the indication to charge the battery bank: selecting, based on the plurality of battery diagnostic information for at least the primary battery and the secondary battery, a given battery, from among the primary battery and the secondary battery, to be charged; and causing the given battery to be charged.

These and other embodiments of technology disclosed herein can optionally include one or more of the following features.

In some embodiments, the primary battery enclosure may further include a plurality of primary battery mounting feet that enables the primary battery to be removably mounted at one or more surfaces of the RV, and the secondary battery enclosure may further include a plurality of secondary battery mounting feet that enables the secondary battery to be removably mounted at one or more surfaces of the RV.

In some embodiments, the plurality of secondary battery terminals and the plurality of primary battery terminals may each be staggered to enable the secondary battery and the primary battery to be configured in the series configuration.

In some embodiments, the primary battery may further include a primary battery heater within the primary battery cavity of the primary battery enclosure to maintain a temperature of the primary battery above a threshold temperature in response to the primary battery being selected as the given battery to be charged, and the secondary battery may further include a secondary battery heater within the secondary battery cavity of the secondary battery enclosure to maintain a temperature of the secondary battery above the threshold temperature in response to the secondary battery being selected as the given battery to be charged.

In some embodiments, the operations may further include determining, based on monitoring the plurality of battery diagnostic information for at least the primary battery and the secondary battery, that a current state of charge of the primary battery or the secondary battery has dropped below a threshold state of charge; and in response to determining that the current state of charge of the primary battery or the secondary battery has dropped below the threshold state of charge: causing a corresponding discharge path of the primary battery or the secondary battery that dropped below the threshold state of charge to be deactivated; determining a duration of time to periodically activate the corresponding discharge path of the primary battery or the secondary battery that dropped below the threshold state of charge; and in response to determining that the duration of time has lapsed at a given instance of time, causing the corresponding discharge path of the primary battery or the secondary battery that dropped below the threshold state of charge to be activated.

In some embodiments, a battery management system (BMS) that is internal to a battery of a battery bank is provided, the BMS includes one or more processors; and memory storing instructions that, when executed, cause the one or more processors to: monitor plurality of battery diagnostic information for the battery bank, the battery bank comprising the battery and at least one additional battery; receive, from a central controller, an indication to charge the battery bank; and in response to receiving the indication to charge the battery bank: select, based on at least the plurality of battery diagnostic information for the battery bank, a given battery, from among the battery and the at least one additional battery, to be charged; and cause the given battery to be charged.

In addition, some embodiments include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some embodiments also include one or more non-transitory computer readable storage media storing computer instructions executable by one or more processors to perform any of the aforementioned methods. Some embodiments also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors of a primary battery management system (BMS) of a primary battery of a battery bank, the method comprising:
monitoring at least one battery diagnostic of a plurality of battery diagnostic information for the battery bank, the battery bank comprising the primary battery and a plurality ofecondary batteries;
receiving, from a central controller, an indication to charge the battery bank; and
in response to receiving the indication to charge the battery bankselecting, based on at least one information of the plurality of battery diagnostic information for the battery bank, a given battery, from among the primary battery and the plurality of secondary batteries, to be charged; and
causing the given battery to be charged.

2. The method of claim 1, wherein the indication to charge the battery bank fails to provide any indication of the given battery to be charged.

3. The method of claim 1, wherein the primary BMS of the primary battery is internal to the primary battery enclosure.

4. The method of claim 3, wherein each of the plurality of secondary batteries include a corresponding secondary BMS that is internal to a corresponding one of the plurality of secondary battery enclosures.

5. The method of claim 4, wherein the primary BMS of the primary battery is communicatively coupled to each of the corresponding secondary BMS' of the plurality of secondary batteries.

6. The method of claim 5, wherein the primary battery and at least one secondary battery, of the one or more secondary batteries, are configured in a parallel configuration via corresponding staggered battery terminals.

7. The method of claim 6, wherein the primary battery and at least one additional secondary battery, of the plurality of secondary batteries and that is in addition to the at least one secondary battery, are configured in a series configuration via the corresponding staggered battery terminals.

8. The method of claim 4, wherein the primary BMS of the primary battery communicates with each of the corresponding secondary BMS' of the plurality of secondary batteries using an RV-C communications protocol, a J1939 communications protocol, or a NMEA 2000 communications protocol.

9. The method of claim 4, wherein the plurality of battery diagnostic information for the battery bank comprises one or more of:
a corresponding set of battery health metrics for the primary battery and for each of the plurality of secondary batteries, or
a corresponding set of operating parameters for the primary battery and for each of the plurality of secondary batteries.

10. The method of claim 9, wherein the plurality of battery diagnostic information is communicated to the primary BMS of the primary battery and from the corresponding secondary BMS of each of the plurality of secondary batteries.

11. The method of claim 4, further comprising:
receiving, from the corresponding secondary BMS of each of the plurality of secondary batteries, a message that includes (1) a corresponding indication of a configuration status of each of the plurality of secondary batteries, and (2) a corresponding unique identifier of each of the plurality of secondary batteries.

12. The method of claim 11, wherein selecting the given battery to be charged is further based on the message received from each of the plurality of secondary batteries.

13. The method of claim 1, further comprising:
continued monitoring of the plurality of battery diagnostic information for the battery bank; and
in response to determining that the given battery is charged:
selecting, based on at least the plurality of battery diagnostic information for the battery bank, an additional given battery, from among the primary battery and the plurality of secondary batteries and that is in addition to the given battery, to be charged; and
causing the additional given battery to be charged.

14. The method of claim 1, further comprising:
storing, in memory of the primary BMS of the primary battery, the plurality of battery diagnostic information for the battery bank over a duration of time; and
enabling a user to access the plurality of battery diagnostic information for the battery bank over the duration of time.

15. A system of batteries for a recreational vehicle (RV), the system of batteries comprising:
a primary battery comprising:
a primary battery enclosure including at least a primary battery cavity, a plurality of primary battery communication ports, and a plurality of primary battery terminals;
a plurality of primary battery cells that are contained within the primary battery cavity of the primary battery enclosure; and
a primary battery battery management system (BMS) that is contained within the primary battery cavity of the primary battery enclosure, wherein the primary battery BMS includes one or more primary battery BMS processors and primary battery BMS memory;
a secondary battery comprising:
a secondary battery enclosure including at least a secondary battery cavity, a plurality of secondary battery communication ports, and a plurality of secondary battery terminals, wherein each the plurality of secondary battery terminals is connected to a corresponding the plurality of primary battery terminals in manner that enables the secondary battery and the primary battery in a parallel configuration or in a series configuration;
a plurality of secondary battery cells that are contained within the secondary battery cavity of the secondary battery enclosure; and
a secondary battery BMS that is contained within the secondary battery cavity of the secondary battery enclosure and that includes at least one or more secondary battery BMS processors and secondary battery BMS memory; and
wherein the one or more primary BMS processors are configured to perform operations stored in the primary BMS memory, the operations comprising:
monitoring, based on communication between the primary battery and the secondary battery via the plurality of primary battery communication ports and the plurality of secondary battery communication ports, battery diagnostic information for at least the primary battery and the secondary battery;
receiving, from a central controller of the RV, an indication to charge a battery of the RV, wherein the indication to charge the battery of the RV does not identify the primary battery or the secondary battery; and
in response to receiving the indication to charge a battery bank defined by the primary battery and the secondary battery:
selecting, based on the battery diagnostic information for at least the primary battery and the secondary battery, a given battery, from among the primary battery and the secondary battery, to be charged; and
causing the given battery to be charged.

16. The system of batteries of claim 15, wherein the primary battery enclosure further includes a plurality of primary battery mounting feet that enables the primary battery to be removably mounted at one or more surfaces of the RV, and wherein the secondary battery enclosure further includes a plurality of secondary battery mounting feet that enables the secondary battery to be removably mounted at the one or more surfaces of the RV.

17. The system of batteries of claim 15, wherein the plurality of secondary battery terminals and the plurality of primary battery terminals are each staggered to enable the secondary battery and the primary battery to be configured in the series configuration.

18. The system of batteries of claim 15, wherein the primary battery further includes a primary battery heater within the primary battery cavity of the primary battery enclosure to maintain a temperature of the primary battery above a threshold temperature in response to the primary battery being selected as the given battery to be charged, and wherein the secondary battery further includes a secondary battery heater within the secondary battery cavity of the secondary battery enclosure to maintain a temperature of the secondary battery above the threshold temperature in response to the secondary battery being selected as the given battery to be charged.

19. The system of batteries of claim 15, the operations further comprising:
determining, based on monitoring the battery diagnostic information for at least the primary battery and the secondary battery, that a current state of charge of the primary battery or the secondary battery has dropped below a threshold state of charge; and
in response to determining that the current state of charge of the primary battery or the secondary battery has dropped below the threshold state of charge:
causing a corresponding discharge path of the primary battery or the secondary battery that dropped below the threshold state of charge to be deactivated;
determining a duration of time to periodically activate the corresponding discharge path of the primary battery or the secondary battery that dropped below the threshold state of charge; and
in response to determining that the duration of time has lapsed at a given instance of time, causing the corresponding discharge path of the primary battery or the secondary battery that dropped below the threshold state of charge to be activated.

20. A battery management system (BMS) that is internal to a battery of a battery bank, the BMS comprising:
one or more processors; and
memory storing instructions that, when executed, cause the one or more processors to:
monitor battery diagnostic information for the battery bank, the battery bank comprising the battery and at least one additional battery;
receive, from a central controller, an indication to charge the battery bank; and
in response to receiving the indication to charge the battery bank:
select, based on at least the battery diagnostic information for the battery bank, a given battery, from among the battery and the at least one additional battery, to be charged; and
cause the given battery to be charged.
